(19) United States
(12) Patent Application Publication
(10) Pub. No.: US 2006/0182059 A1
(43) Pub. Date: Aug. 17, 2006

(54) Transport bearer setting control system and method in a mobile communication system, and radio access network for this system

(75) Inventor: Naoto Itaba, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/351,100

(22) Filed: Feb. 10, 2006

(30) Foreign Application Priority Data
Feb. 16, 2005 (JP) 2005-038548

(51) Int. Cl. H04Q 7/00

(52) U.S. Cl. 370/329

(57) ABSTRACT

Transport bearers are set in advance before the occurrence of call setting and information necessary for specifying transport bearers is stored in each of the transport bearer management units of a Node B and an RNC. When setting a call, the use of transport bearers that have been set in advance shortens the procedure for setting the transport bearer. As a result, the time required from the origination of call by a UE to the actual reception of the service can be reduced.

### BACKGROUND OF THE INVENTION

1. Field of the Invention

The present invention relates to a transport bearer setting control system and method of a mobile communication system and to a radio access network, and more particularly to a transport bearer setting control method of an UTRAN (Universal Mobile Telecommunication System Terrestrial Radio Access Network) in W-CDMA (Wideband Code Division Multiple Access).

2. Description of the Related Art

UTRAN is prescribed by both the 3GPP (3^{rd} Generation Partnership Project) and in a non-patent document (“W-CDMA Mobile Communication System,” Maruzen Publishing, 2001, pp. 96-97). As shown in FIG. 1, this UTRAN 2 includes RNS (Radio Network Systems) 3 and 4, RNS 3 and 4 being composed of RNCs (Radio Network Controllers) 5 and 6, respectively, and Nodes B (radio base stations) 7-10 that are provided subordinate to each RNC.

Each of these Nodes B has one or a plurality of cells (shown by ovals in the figure), and UEs (not shown), which are mobile communication terminals, are present in these cells. Each RNC 5 and 6 is connected to CN (Core Network) 1 by means of an interface referred to as “lu” and connected to each of subordinate Nodes B 7-10 by means of interfaces referred to as “lub.”

Referring now to FIG. 2, RNS 4 (RNC) that controls UE 15 is referred to as “S (Serving) RNS (SRNC),” and when UE also maintains connections with RNSs other than SRNS, signals such as control signals from SRNS 4 reach UE by way of other RNSs (RNCs) by means of an interfaces referred to as “lur.” In this case, the other RNS 3 (RNC) is referred to as a “D (Drift) RNS (DRNC).”

In order for SRNS 4 to communicate with a UE, transport bearers must be set in interfaces lub and lur (when communication passes by way of DRNS 3). Control signals (RRC (Radio Resource Control) messages) and user data are transferred on these transport bearers.

As shown by the transport bearer setting control procedure between SRNC and Node B that is shown in FIG. 3, when setting a transport bearer, an ALCAP (Access Link Control Application Part) procedure is used and the SRNC activates the ALCAP procedure (NBAP (Node B Application Part) Request Message (Step S1). Information that is necessary for setting the transport bearer (for example, the address of the transport bearer on the Node B side) is communicated from Node B to the SRNC by means of an NBAP message (Step S2).

An ALCAP request message is then transmitted from the SRNC to Node B (Step S3), and an ALCAP response message is returned from Node B to the SRNC (Step S4), whereby a transport bearer is set between the SRNC and Node B (Step S5).

When setting a transport bearer in interface lur, Node B in FIG. 3 is replaced by a DRNC, and the NBAP is replaced by an RNSAP (Radio Network System AP).

The Transport Layer Address in FIG. 3 shows the address of the transport bearer, and the Binding ID is used to establish a correspondence between the UE and that transport bearer that is recognized in the application (NBAP or RNSAP). In other words, the SRNC is able to recognize the Binding ID based on the information of the UE, and moreover, is able to recognize the Transport Layer Address that corresponds to the object UE based on the Binding ID. As a result, the SRNC is able to recognize the correspondence of the UE and transport bearer.

From the UE side, the time required from originating a call to actually receiving a service is preferably short. The time required for setting the transport bearer is included within the time from the call origination until receiving the service. It is therefore considered extremely inefficient from the standpoint of reducing the time required for setting a call for a transport bearer to be set when a call is originated, cut off when the call is released, and then set again when a call is again originated.

In addition, generally, when determining the characteristics of transport bearers, the transport bearers are classified into typical service groups rather than subdividing service categories. As a result, there is little need to set transport bearers having characteristics that are specialized for each UE.

### SUMMARY OF THE INVENTION

It is an object of the present invention to provide a radio access network (RAN) and a transport bearer setting control system and method in a mobile communication system that can reduce the call connection time to reduce the time required from the origination of a call by a UE to the actual reception of a service.

A transport bearer setting control system of the present invention is a system for controlling a setting of transport bearers between a radio base station and a radio network controller, that includes means for effecting a transport bearer setting control that is independent of procedures for setting calls.

A transport bearer setting control method of the present invention is a method of controlling a setting of transport bearers between a radio base station and a radio network controller, and that includes a step of effecting a transport bearer setting control independent of procedures for setting calls.

A radio access network (RAN) of the present invention uses the above described transport bearer setting control system

A program of the present invention is for causing a computer to execute a transport bearer setting control method between a radio base station and a radio network controller, and the program includes a process for effecting a transport bearer setting control independent of procedures for setting calls.

Regarding the effect of the present invention, instead of responding to an originated call and then setting a transport bearer, transport bearers are set in advance, and then when responding to the generation of a call, a transport bearer from among the transport bearers that have been set is assigned to the call. Then, when the call is released, the transport bearer that was used in that call is assigned to another newly generated call to enable a reduction of the time for call connection.

The present invention has the effect of enabling a shortening the procedure of setting transport bearers by employing transport bearers that have been set in advance when setting a call, and thus enabling a shortening of the time required for setting a call. The present invention further has the effect of enabling adjustment of the number of transport bearers that are set in advance in accordance with the state of use of the transport bearers.

The above and other objects, features, and advantages of the present invention will become apparent from the following description with reference to the accompanying drawings, which illustrate examples of the present invention.

### BRIEF DESCRIPTION OF THE DRAWINGS

FIG. 1 shows the configuration of a UTRAN;

FIG. 2 shows an example of the control of a UE by way of a DRNC;

FIG. 3 is a sequence chart showing the procedure of setting a transport bearer;

FIG. 4 is a function block diagram of an embodiment of the present invention;

FIG. 5 is a sequence chart of the operations of an embodiment of the present invention;

FIG. 6 shows an example of the stored information in the transport bearer management unit when the SRNC transmits an NBAP message;

FIG. 7 shows an example of the stored information in the transport bearer management unit when Node B receives the NBAP message and transmits the response to the SRNC;

FIG. 8 shows an example of the stored information in the transport bearer management unit when the SRNC transmits an ALCAP message, or when Node B transmits a response to the ALCAP message that has been received from the SRNC;

FIG. 9 is a sequence chart showing the procedures for using transport bearers that have been set in advance to set a call in an embodiment of the present invention; and

FIG. 10 is a flow chart showing an example of the procedure for adjusting the number of transport bearers that have been set by the transport bearer management unit, and moreover, that can be used in an embodiment of the present invention.

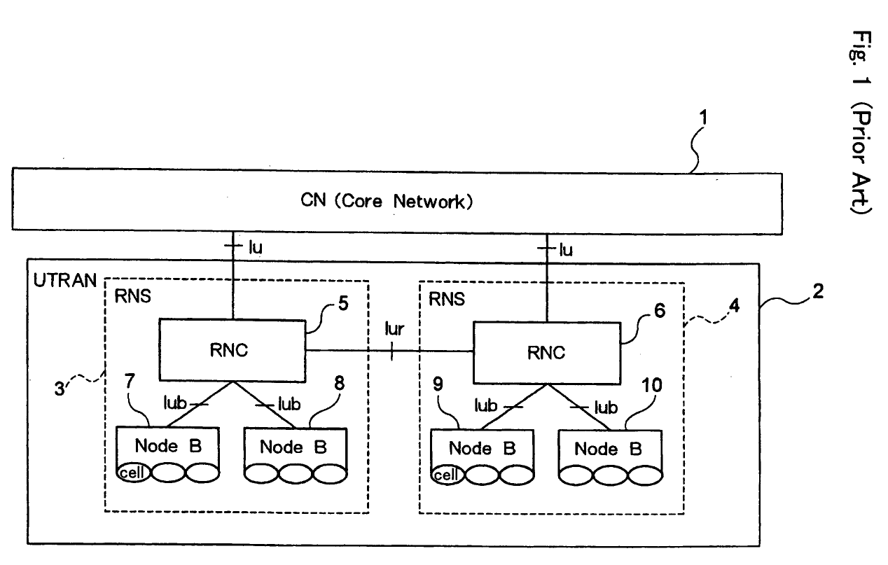

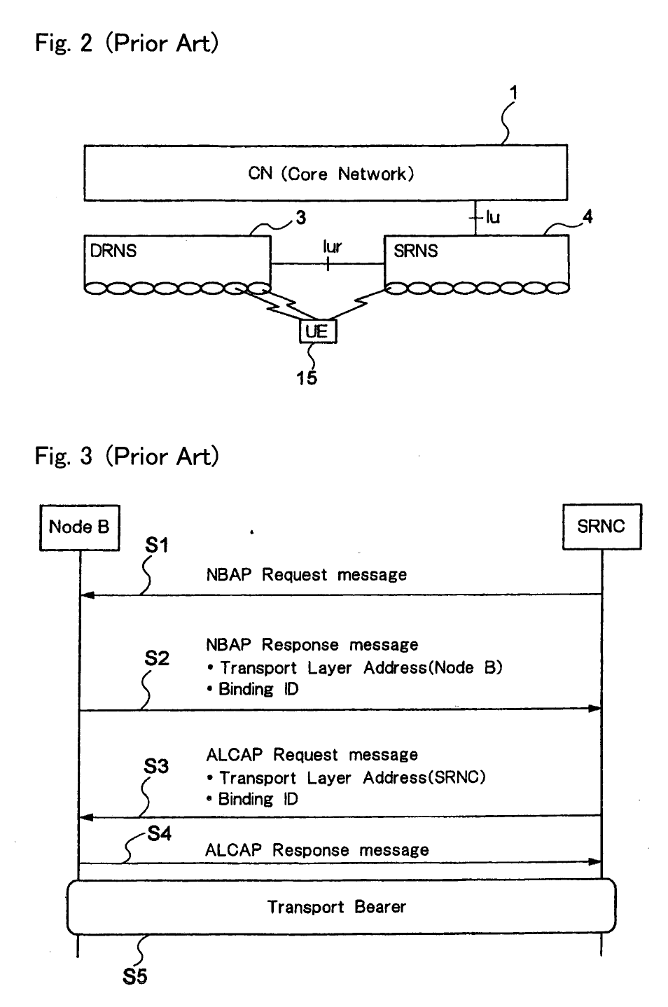

### DETAILED DESCRIPTION OF THE PREFERRED EMBODIMENTS

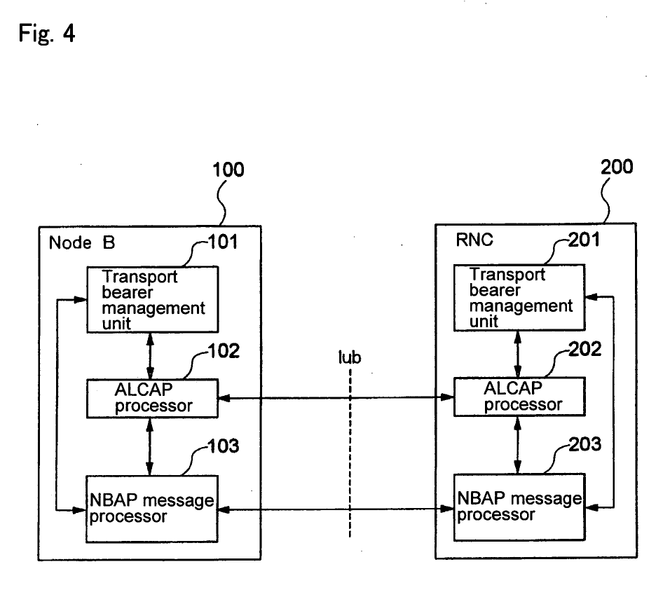

Explanation next regards an embodiment of the present invention with reference to the accompanying figures. FIG. 4 is a schematic view of the configuration of an embodiment of the present invention, and is an example of a case in which a transport bearer is set in interface lub between Node B 100 and RNC 200. Node B 100 and RNC 200 both have identical configurations, and the configurations of these components are shown with “100” used in the reference numbers of the constituent elements of Node B100 and “200” used in the reference numbers of the constituent elements of RNC 200.

Transport bearer management units 101 and 201 manage information (characteristics, Transport Layer Addresses, Binding IDs) that relates to transport bearers, and further monitor the state of use of transport bearers. ALCAP processors 102 and 202 set, release and alter the characteristics of the transport bearers. NBAP message processors 103 and 203 construct and analyze the structure of NBAP messages, and further instruct ALCAP processors 102 and 202 to set, release, and alter the characteristics of transport bearers.

NBAP message processors 103 and 203 communicate to transport bearer management units 101 and 201 the Binding ID, which is information for establishing the correspondence between a UE and a transport bearer. Transport bearer management units 101 and 201 can refer to the Binding IDs that have been communicated from NBAP message processors 103 and 203 to recognize the transport bearer that corresponds to the Binding ID.

When setting or releasing a call, NBAP message processors 103 and 203 report the Binding ID that corresponds to that call to transport bearer management units 101 and 201, and at the same time, reports to transport bearer management units 101 and 201 whether the transport bearer that corresponds to the Binding ID is in use or has been released. In addition, transport bearer management units 101 and 201 are assumed not to assign to a UE a transport bearer that is in use.

FIG. 4 is a block diagram specific to lub interfaces, but this diagram can be changed to a diagram specific to lur interfaces by replacing Nodes B with a DRNC, replacing the RNC with an SRNC, and further, replacing the NBAP with an RNSAP.

Information relating to transport bearers that is set by NBAP message processors 103 and 203 and ALCAP processors 102 and 202 is reported to transport bearer management units 101 and 201. Transport bearer management units 101 and 201 on the RNC side and the Node-B side hold the same information.

When setting a call, NBAP message processor 203 on the RNC side acquires from transport bearer management unit 201 information of the transport bearer that is appropriate to the service received by the object UE and then sets this information in an NBAP message to report to Node B. NBAP message processor 103 of Node B, having received the NBAP message, acquires the information of the transport bearer from the NBAP message and reports the information to transport bearer management unit 101.

By means of these processes, recognition of the transport bearer that the object UE uses can be shared in both the RNC and Node B, and similar conditions are obtained at the time that the connection of a call is completed as when setting the transport bearer at the time of setting a call.

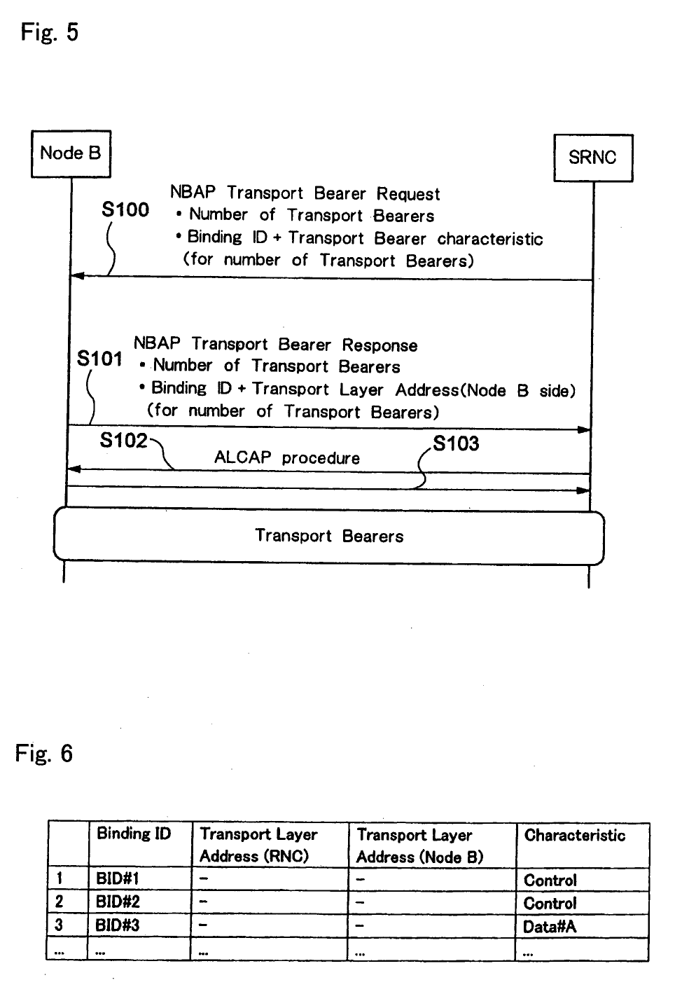

Explanation next regards the operations of an embodiment of the present invention. FIG. 5 shows a message sequence chart of the method of setting a transport bearer in advance before setting a call. The NBAP message that is used in the sequence of FIG. 5 is assumed to be an already existing NBAP message to which parameters required in the present invention have been added or a new NBAP message that contains parameters necessary to the present invention.

The SRNC first reports to Node B in an NBAP message (here assumed to be a Transport Bearer Request): the number of transport bearers that are set in advance before setting a call, the characteristics of each transport bearer, and the Binding IDs (Step S100). At this time, the SRNC stores in the transport bearer management unit the information of the transport bearer that was reported to Node B by the NBAP message, as in the example that is shown in FIG. 6. At this time, moreover, the RNC-side Transport Layer Address is not stored in the transport bearer management unit. In addition, the Node B-side Transport Layer Address that corresponds to the Binding ID is reported to the SRNC by Node B in a Response message, and is therefore unclear at this time.

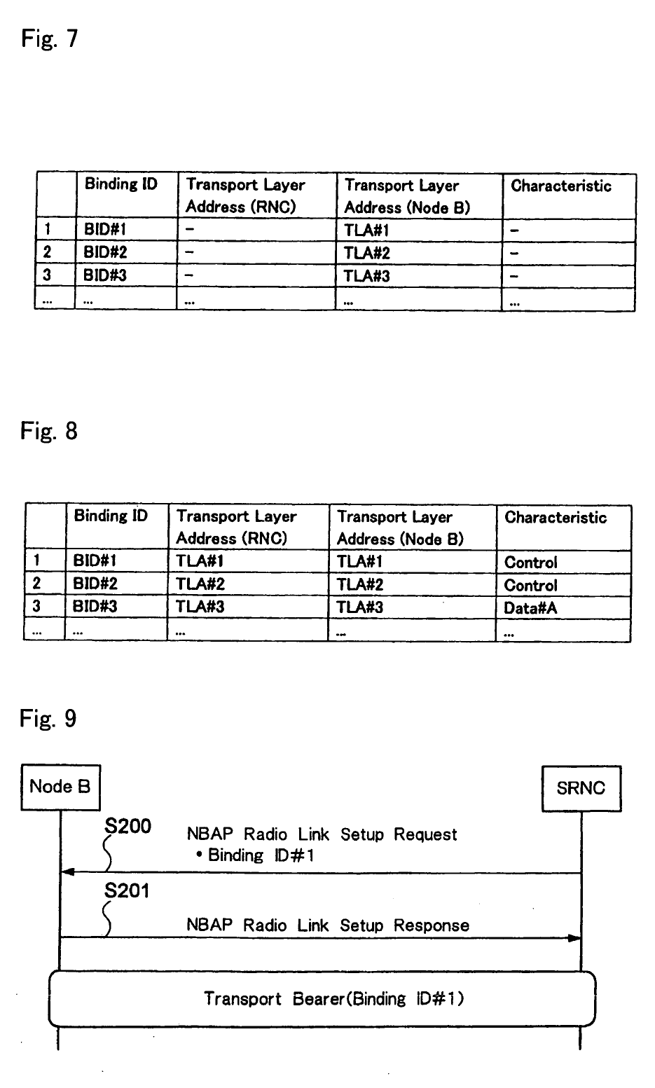

Node B, having received the NBAP Request message, stores the Node B-side Transport Layer Address in the transport bearer management unit in Node B as shown in FIG. 7, and reports the information of the Transport Layer Address and Binding ID to the SRNC by an NBAP response message (Step S101). The SRNC activates ALCAP (Step S102), and when setting the transport bearer, stores the RNC-side Transport Layer Address and the Node B-side Transport Layer Address that was received in the NBAP response message in the transport bearer management unit, as shown in FIG. 8.

The destination address of the ALCAP message that is transmitted from the SRNC to Node B is the Node B-side Transport Layer Address, and this ALCAP message contains the RNC-side Transport Layer Address, the Binding ID that corresponds to this Transport Layer Address, and further, the “characteristic” which is the characteristic of the transport bearer.

When it is possible to set the transport bearer that has been designated from the SRNC, the ALCAP processor of Node B stores information similar to FIG. 8 in the transport bearer management unit and reports the success of setting the transport bearer to the SRNC (Step S103).

When setting of the transport bearer fails, the ALCAP processor of Node B deletes the information of the transport bearer for which setting failed from the transport bearer management unit and reports the failure of the setting of the transport bearer to the SRNC. As with the Node B side, the ALCAP processor on the SRNC side also deletes the information of the transport bearer for which setting failed.

Explanation next regards the method of selecting a transport bearer when setting a call. FIG. 9 shows a message sequence chart for setting a call for a case in which transport bearers are set in advance before carrying out call setting. When the SRNC sets a call, the SRNC-side NBAP message processor reports to Node B the Binding ID of transport bearers that are not being used in other UEs from the transport bearer management unit (Step S200).

The NBAP message processor of Node B acquires from the Node B-side transport bearer management unit the transport bearer that corresponds to the Binding ID that has been reported from the SRNC. Since the information of the Transport Layer Addresses of the RNC and Node B is also stored in the transport bearer management unit, the use of the Transport Layer Address that corresponds to the Binding ID enables communication between the RNC and Node B (Step S201).

When a call is to be set but all of the transport bearers that have been set in advance are in use or there is no transport bearer having characteristics that are appropriate to the call, the normal procedure is used to set the transport bearer as shown in FIG. 3. In this case as well, the information of the transport bearer for which setting has been completed is stored in the transport bearer management units on the Node B side and RNC side.

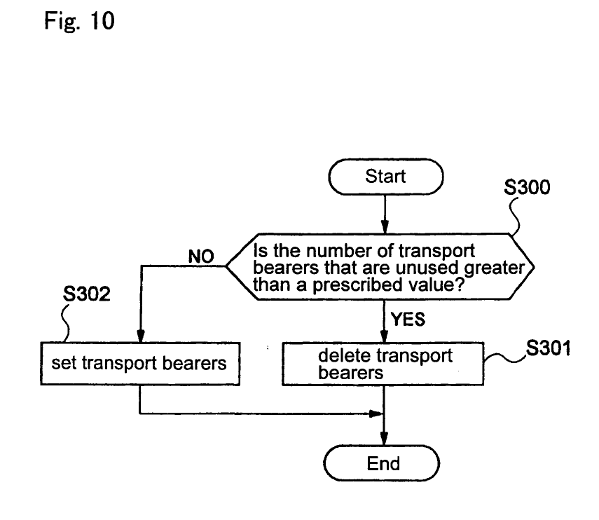

It is further assumed that the transport bearer management units execute transport bearer management as shown in FIG. 10. In other words, the transport bearer management units perform a count of the number of transport bearers that are still unused for each characteristic, and if the number of transport bearers that are unused is greater than a prescribed value that has been set in advance (“Yes” in Step S300), the transport bearer management units request the ALCAP processor to delete the transport bearers, and upon the completion of the deletion, the ALCAP processor deletes the information of the object transport bearers from the transport bearer management units on the RNC and Node B sides (Step S301). On the other hand, when the number of transport bearers that are unused is less than the prescribed value that has been set in advance (“No” in Step S300), the transport bearer management units request the NBAP message processor to set transport bearers and execute the procedure shown in FIG. 5 (Step S302).

It will be obvious that the above-described processing operations can be realized by recording the operation procedures as a program in advance on a recording medium such as ROM, and then causing a CPU, i.e., a computer, read the program and execute these operations.

While preferred embodiments of the present invention have been described using specific terms, such description is for illustrative purposes only, and it is to be understood that changes and variations may be made without departing from the spirit or scope of the following claims.

What is claimed is:

1. A transport bearer setting control system, which is a system for controlling a setting of transport bearers between a radio base station and a radio network controller, wherein both said radio base station and said radio network controller comprising:
a transport bearer management unit managing information of characteristics, transport layer Addresses and binding IDs that relates to transport bearers and monitoring states of use of transport bearers;
ALCAP (Access Link Control Application Part) processors setting, releasing and altering the characteristics of the transport bearers; and
NBAP (Node B Application Part) message processors constructing and analyzing a structure of NBAP messages of a number of transport bearers that are set in advance before setting a call, the characteristics of each transport bearer, and the binding IDs, and further instructing said ALCAP processors to set, release, and alter the characteristics of transport bearers.

2. A transport bearer setting control system, which is a system for controlling a setting of transport bearers between a radio base station and a radio network controller, that includes means for effecting a transport bearer setting control that is independent of procedures for setting calls.

3. The transport bearer setting control system according to claim 2, wherein said means selects as desired characteristics and number of transport bearers that are to be set in advance to realize said setting of transport bearers.

4. The transport bearer setting control system according to claim 3, wherein said means deletes surplus transport bearers when the number of transport bearers that are still unused is greater than a prescribed value, and sets the number of deficient transport bearers when the number of transport bearers is less than the prescribed value.

5. The transport bearer setting control system according to claim 2, further including means for, in response to a request for setting said calls, assigning a transport bearer for said call from transport bearers that have been set in advance.

6. The transport bearer setting control system according to claim 2, wherein said transport bearer setting control is realized among a plurality of radio network controllers instead of by said radio base station.

7. The radio access network that uses the transport bearer setting control system according to claim 1.

8. The radio access network that uses the transport bearer setting control system according to claim 2.

9. The radio access network that uses the transport bearer setting control system according to claim 3.

10. The radio access network that uses the transport bearer setting control system according to claim 4.

11. The radio access network that uses the transport bearer setting control system according to claim 5.

12. The radio access network that uses the transport bearer setting control system according to claim 6.

13. A transport bearer setting control method, which is a method of controlling a setting of transport bearers between a radio base station and a radio network controller, and that includes a step of effecting a transport bearer setting control independent of procedures for setting calls.

14. The transport bearer setting control method according to claim 13, wherein said step realizes said setting of transport bearers by selecting as desired characteristics and number of transport bearers that are set in advance.

15. The transport bearer setting control method according to claim 14, further including a step of deleting surplus transport bearers when the number of transport bearers that are still unused is greater than a prescribed value and setting the number of deficient transport bearers when the number of transport bearers is less than the prescribed value.

16. The transport bearer setting control method according to claim 13, further including a step of, in response to said request for setting said calls, assigning a transport bearer for said call from transport bearers that have been set in advance.

17. The transport bearer setting control method according to claim 13, wherein said transport bearer setting control is realized among a plurality of radio network controllers instead of by said radio base station.

18. A program for causing a computer to execute a transport bearer setting control method between a radio base station and a radio network controller, said program including a process for effecting a transport bearer setting control independent of procedures for setting calls.
